(19) United States
(12) Patent Application Publication
(10) Pub. No.: US 2004/0049753 A1
(43) Pub. Date: Mar. 11, 2004

(54) System for estimating performance of integrated circuit in register transfer level

(75) Inventor: Chie Kabuo, Kyoto (JP)

Correspondence Address: McDERMOTT, WILL & EMERY, 600 13th Street, N.W., Washington, DC, 20005-3096, US

(73) Assignee: MATSUSHITA ELECTRIC INDUSTRIAL CO., LTD.

(21) Appl. No.: 10/654,884

(22) Filed: Sep. 5, 2003

(30) Foreign Application Priority Data
Sep. 10, 2002 (JP) P2002-264308

(51) Int. Cl. G06F 17/50; G06F 9/45

(52) U.S. Cl. 716/6

(57) ABSTRACT

In estimating the performance of an integrated circuit, provided are RTL description inputting means for inputting an RTL logic description and creating the correspondence of a substitution portion with respect to each of signals; invariable attribute setting means for setting an invariable attribute with respect to a signal whose correspondence has been created; partial circuit synthesizing means for logically optimizing a partial circuit except for the signal having the invariable attribute; invariable part optimizing means for inserting a buffer in order to satisfy a design rule with respect to the signal having the invariable attribute; performance calculating means for calculating the performance of the integrated circuit; and display means for displaying the result of the performance calculation and the logic description. Thus, the performance can be estimated in consideration of a design restriction and a design rule and the kind of a device model, so as to specify a faulty portion from the viewpoint of the performance on the logic description.

### BACKGROUND OF THE INVENTION

The present invention relates to a system for estimating the performance of a semiconductor integrated circuit and, more particular, to a system for estimating the performance of an integrated circuit in a register transfer level, in which the area and delay time of the integrated circuit are evaluated at a stage of a logic description in a register transfer level.

With the increasing prevalence of a hardware description language (abbreviated as “an HDL”), there has been a standardized design technique in which the logic description of an integrated circuit is created in a register transfer level (abbreviated as “an RTL”), followed by logic verification, and then, a logic synthesis and placement and routing are carried out by the use of an automatic design tool.

Furthermore, the deep submicron in a semiconductor process has made conspicuous an influence of an interconnect delay on the operating speed of an integrated circuit. In view of this, a detailed interconnect delay is determined before a physical design stage: there has been a prevailed design technique in which the convergence of timing is enhanced in consideration of a physical design from the beginning of a design. In this case, a technique for estimating the area or timing of a chip after the physical design is needed at the beginning of the design. In many cases, a logic synthesis has been conducted on an exploratory basis. As a result, estimation has been carried out by the use of a net list of a gate level.

In the meantime, it takes much time to conduct the logic synthesis. Moreover, it is difficult to make the result of the logic synthesis and the RTL logic description correspond to each other. From this viewpoint, the performance of the integrated circuit has been estimated and evaluated directly based on the RTL logic description. This is because the performance of the integrated circuit can be improved with the remarkably reduced number of man-hours by enhancing the quality of the RTL logic description on the basis of the evaluation of the performance at an RTL design stage in comparison with measures at downstream design stages.

Normally, a logic library for use in conducting the logic synthesis includes a composite cell, in which AND gates and OR gates, having an effect for reducing the number of routes and gates, are combined with each other. Additionally, a buffer is inserted into a signal of a high fan-out or a long-distance route by a tool for the logic synthesis in accordance with a design rule with respect to “a slew” of timing.

With the progress of the deep submicron in the semiconductor process from 0.13 μm to 0.10 μm, an adverse influence of an interconnect delay becomes marked. Therefore, the estimation of the performance in consideration of such an adverse influence has been needed.

However, the following two problems have arisen: one is that a 2-input NAND, a 2-input NOR, an inverter and the like in a simple structure are only considered as a device model, which can be used for logic optimization; and the other is that the performance is evaluated in dependence on the RTL logic description while no measures remain taken with respect to a signal of a high fan-out. Consequently, the accuracy of the estimation becomes degraded in the process of the deep submicron, in which the adverse influence of the interconnect delay becomes marked.

### SUMMARY OF THE INVENTION

In view of the problems described above, a principal object of the present invention is to provide a system for estimating the performance of an integrated circuit in a register transfer level, in which the performance of an integrated circuit can be estimated with high accuracy, and further, the quality of an RTL logic description can be improved based on the evaluation of the performance in consideration of a timing restriction and a design rule and the kind of cell such as a composite cell included in a library while keeping the correspondence to the RTL logic description.

A system for estimating the performance of an integrated circuit in a register transfer level according to the present invention, in which the performance of an integrated circuit is estimated based on a logic description of a register transfer level of the integrated circuit, comprises: a library storing therein a device model for configuring the integrated circuit; RTL description inputting means for inputting the logic description and creating the correspondence of a substitution portion with respect to each of signals in the description; syntax analyzing means for creating a syntax analyzing tree based on the logic description; invariable attribute setting means for setting an invariable attribute with respect to a signal whose correspondence has been created by the RTL description inputting means in the syntax analyzing tree; partial circuit synthesizing means for logically optimizing a partial circuit except for a signal having the invariable attribute from the syntax analyzing tree so as to allocate the device model in the library; invariable part optimizing means for inserting a buffer in order to satisfy a design rule with respect to the signal having the invariable attribute; performance calculating means for calculating the performance of the integrated circuit; and display means for displaying the result of the performance calculation and the logic description.

Thus, a net list can be created in consideration of a timing restriction, the design rule and the kind of device model included in a library such as a composite logic while keeping the correspondence to the RTL logic description. As a result, the performance of the integrated circuit can be estimated with high accuracy at a design stage of the RTL, and further, a faulty portion from the viewpoint of performance can be specified on the RTL logic description.

Moreover, a system for estimating the performance of an integrated circuit in a register transfer level according to the present invention, in which the performance of an integrated circuit is estimated based on a net list of a gate level including a signal having correspondence to a logic description of a register transfer level, comprises: floorplan means for arranging a device model inside of the net list of the gate level within a specified region; invariable part optimizing means for inserting a buffer based on the arrangement of information of the floorplan means, in order to satisfy a design rule with respect to the signal having the correspondence to the logic description; interconnection predicting means for predicting the interconnection between devices based on the arrangement information; performance calculating means for calculating the performance of the net list of the gate level by the use of an interconnection prediction value by the interconnection predicting means; and display means for displaying the result of the performance calculation, the logic description and the result of a floorplan.

Thus, an interconnect delay between devices occupying a great rate in a deep submicron process can be estimated with higher accuracy.

Additionally, the system for estimating the performance of an integrated circuit in a register transfer level according to the present invention in the above-described configuration further comprises delay recalculating means for creating the net list whose logic is optimized including the signal having the invariable attribute with respect to a selected path in accordance with a request from the outside, so as to calculate a delay of the path.

Thus, the result of logic optimization including a signal whose invariable attribute is set can be evaluated. As a result, the performance can be estimated with higher accuracy while keeping the correspondence to the RTL logic description.

In addition, a system for estimating the performance of an integrated circuit in a register transfer level according to the present invention, in which the performance of an integrated circuit is estimated based on a net list of a gate level including a signal having correspondence to a logic description of a register transfer level, comprises: display means for displaying a reach delay time of each of signals, which reaches a partial circuit on the net list of the gate level corresponding to a specified portion on the logic description.

Thus, the RTL design can be carried out in consideration of the reach delay time of each of the input signals into the partial circuit, thereby improving the quality of the RTL logic description.

The foregoing and other aspects will become apparent from the following description of the invention when considered in conjunction with the accompanying drawing figures.

### BRIEF DESCRIPTION OF THE DRAWING FIGURES

FIG. 1 is a diagram illustrating the configuration of a system for estimating the performance of an integrated circuit in a register transfer level in a first embodiment according to the present invention;

FIG. 2A is a diagram illustrating an example of an RTL logic description in the first embodiment, FIG. 2B is a diagram illustrating an example of correspondence between a signal and the RTL logic description, and FIG. 2C is a diagram illustrating an example of the result of partial circuit synthesizing means;

FIG. 3 is a flowchart illustrating operation of invariable part optimizing means in the first embodiment;

FIG. 4A is a diagram illustrating an example of a display of the area and maximum delay of an integrated circuit by display means in the first embodiment, FIG. 4B is a diagram illustrating an example of a display of a path delay, FIG. 4C is a diagram illustrating an example of a display of a circuit, and FIG. 4D is a diagram illustrating an example of a display of the RTL logic description;

FIG. 5A is a diagram illustrating an example of the RTL logic description by display means in the first embodiment, FIG. 5B is a circuit diagram, and FIGS. 5C and 5D are diagrams illustrating examples of a display of a reach delay time to a partial circuit;

FIG. 6A is a diagram illustrating an example of the RTL logic description by display means in the first embodiment, FIG. 6B is a circuit diagram, and FIGS. 6C and 6D are diagrams illustrating examples of a display of a reach delay time to a partial circuit;

FIG. 7 is a diagram illustrating the configuration of a system for estimating the performance of an integrated circuit in a register transfer level in a second embodiment according to the present invention;

FIG. 8 is a flowchart illustrating operation of floorplan means in the second embodiment;

FIG. 9 is a diagram illustrating an example of display means in the second embodiment;

FIG. 10 is a diagram illustrating the configuration of a system for estimating the performance of an integrated circuit in a register transfer level in a third embodiment according to the present invention; and

FIG. 11A is a circuit diagram illustrated in display means by operation of delay recalculating means in the third embodiment, and FIGS. 11B is a diagram illustrating a net list whose logic is optimized by the delay recalculating means.

In all these figures, like components are indicated by the same numerals.

### DETAILED DESCRIPTION

Preferred embodiments according to the present invention will be described below in reference to the accompanying drawing figures.

(First Embodiment)

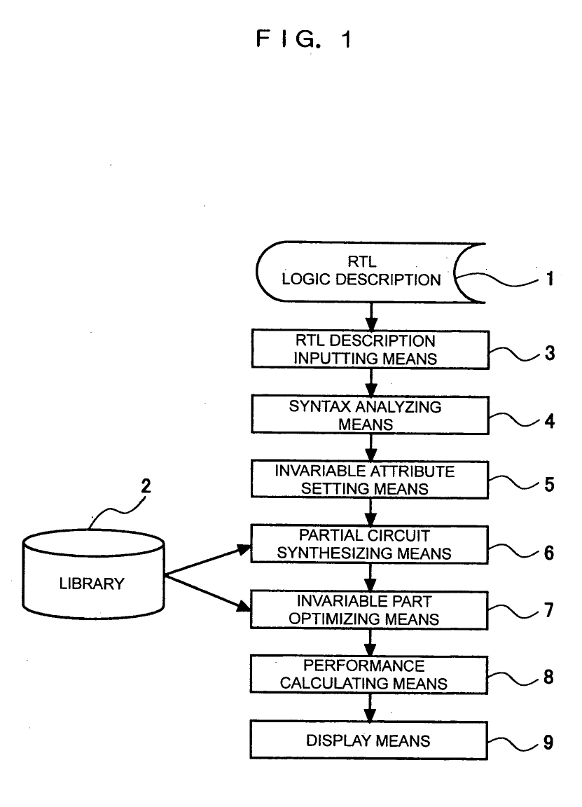

FIG. 1 is a diagram illustrating the configuration of a system for estimating the performance of an integrated circuit in a register transfer level in a first embodiment according to the present invention.

In FIG. 1, reference numeral 1 designates a logic description of a register transfer level (abbreviated as “an RTL”); reference numeral 2 denotes a library storing therein a device model for configuring an integrated circuit; reference numeral 3 designates RTL description inputting means for inputting the RTL logic description 1; reference numeral 4 denotes syntax analyzing means for syntactically analyzing the RTL logic description 1, so as to create a syntax analyzing tree; reference numeral 5 designates invariable attribute setting means for setting an invariable attribute with respect to a signal in the syntax analyzing tree; reference numeral 6 denotes partial circuit synthesizing means for logically optimizing a partial circuit, in which a signal having an invariable attribute is excluded from the syntax analyzing tree, so as to allocate the device model in the library 2; reference numeral 7 designates invariable part optimizing means for inserting a buffer in order to satisfy a design rule with respect to the signal having the invariable attribute; reference numeral 8 denotes performance calculating means for calculating the performance of the integrated circuit; and reference numeral 9 designates display means.

In reference to FIG. 1, explanation will be made on operation of the system for estimating the performance of the integrated circuit in the register transfer level in the present embodiment.

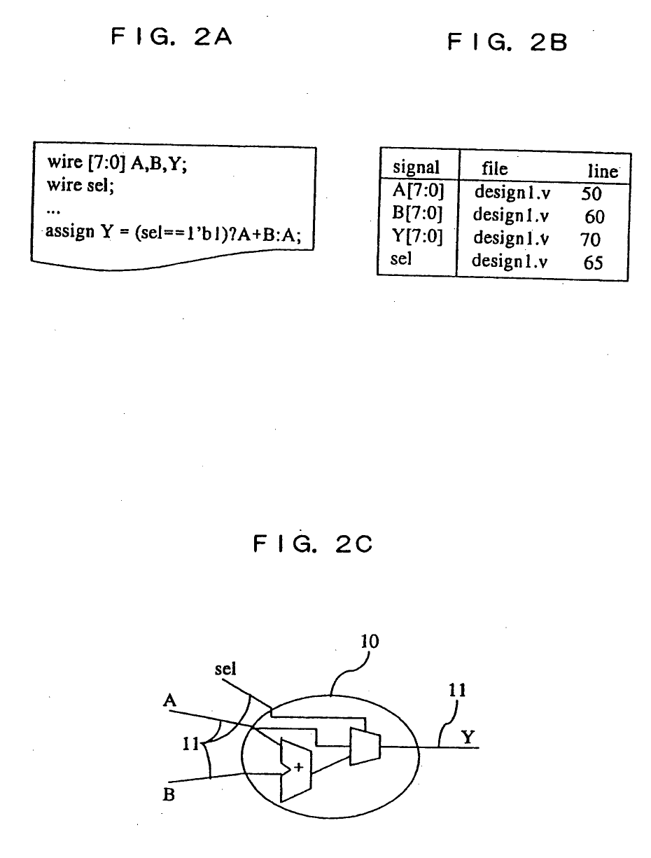

First of all, the RTL description inputting means 3 inputs the RTL logic description 1, and then, a file name and a line number are obtained as a substituted portion with respect to a signal name and a pin name appearing in the description, thereby creating the correspondence to the signal name (see FIG. 2B). In the case of Verilog HDL as a hardware description language, the signal name is recognized based on a wire sentence or a reg sentence, and further, the pin name is recognized based on an output sentence, an input sentence and an inout sentence (see FIG. 2A). Thereafter, the number of a starting line of an always block or an assign sentence including substitution sentences into the signals is made to correspond to the signal. At this time, with respect to a signal having a bit width of 2 or more, unless the substitution sentence is developed in bit, the correspondence is created in a bus description such as A[7:0] as it is. In contrast, if the substitution sentence is developed in bit, the correspondence is created per bit in accordance with the substitution sentence. Moreover, in the case where the same signal name is substituted into the plurality of always blocks or assign sentences, all of the line numbers are made to correspond to the signal. This is exemplified by a description of a three state buffer. Here, since a name cannot be a proper name in the integrated circuit with respect to a signal defined in a function sentence and a task sentence, no correspondence is created.

Subsequently, the syntax analyzing means 4 analyzes the syntax of the input RTL description, and then, creates a syntax analyzing tree (see FIG. 2C). And then, the invariable attribute setting means 5 sets an invariable attribute with respect to a signal having the correspondence to the description in the syntax analyzing tree. At this time, a signal inside the always block expressed in synchronism is allocated to a flip-flop on a net list of a gate level, and therefore, no invariable attribute is set. As for a signal allocated to a latch, no invariable attribute is set, either.

Next, the partial circuit synthesizing means 6 logically optimizes a partial circuit in which the signal having the invariable attribute is excluded from the syntax analyzing tree, allocates the device model in the library 2, and thus, creates the net list of the gate level. A method for the logic optimization and the allocation of the device model may be identical to a normal logic synthesizing method. Here, the name of a flipflop or a latch instance accords with the signal name on the RTL logic description. Furthermore, operating conditions such as a voltage and a temperature or design restrictions of an operating frequency and the like are given similarly to those of a normal logic synthesis.

FIGS. 2A to 2C are diagrams illustrating an example of processing from the RTL description inputting means 3 to the partial circuit synthesizing means 6.

FIG. 2A is a diagram illustrating a part of the RTL logic description to be input, in which there are illustrated a wire sentence for defining a signal and an assign sentence including a substitution sentence with respect to a signal Y. In a simple explanation, signals include signals A, B and Y of 8 bits and a signal sel of 1 bit. Out of two states of the addition result of the signals A and B and the signal A, the addition result (A+B) is selected to be made as the signal Y when the signal sel is “1”.

FIG. 2B is a diagram illustrating an example of the correspondence of the description to the signal defined in the description in FIG. 2A, wherein the file name and the line number are stored. A signal having a bit width is expressed in bus.

FIG. 2C is a diagram illustrating the result of the processing by the partial circuit synthesizing means 6 with respect to the partial circuit expressed by the assign sentence illustrated in FIG. 2A. Reference numeral 10 designates a partial circuit, and reference numeral 11 denotes a signal whose invariable attribute is set. The partial circuit 10 functions as a net list of a gate level of the device model stored in the library 2 by the partial circuit synthesizing means 6.

Subsequently, the invariable part optimizing means 7 inserts a buffer into the signal having the invariable attribute in order to satisfy a design rule such as a limitation of the number of fan-outs. At this time, the correspondence to the description of an original signal name is inherited also with respect to a new signal produced by the insertion of the buffer.

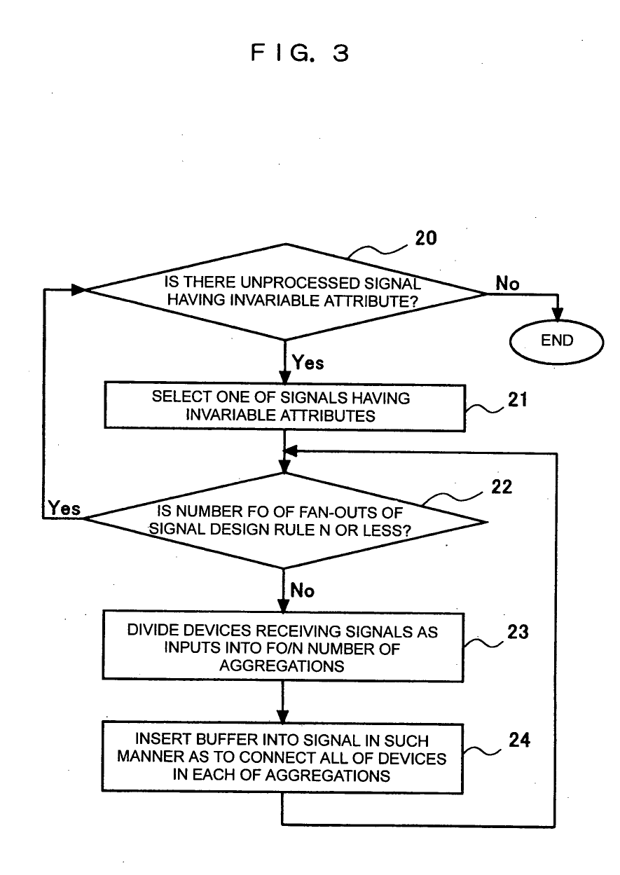

FIG. 3 is a flowchart illustrating the operation of the invariable part optimizing means 7 with respect to the limitation of the number of fan-outs. The operation of the invariable part optimizing means 7 will be explained below in reference to FIG. 3.

In the processing from step 20 to step 22, signals having the number of fan-outs against the design rule are sequentially selected out of the signals having the invariable attributes (e.g., the signals A, B, Y and sel in the example illustrated in FIG. 2C). Specifically, the processing is performed as follows:

In step 20, it is judged whether or not an unprocessed signal having an invariable attribute remains. If the judgment is affirmative, the control routine proceeds to step 21. In step 21, one signal is selected from the signals having the invariable attributes. In step 22, it is judged whether or not the number FO of fan-outs of the selected signal is the maximum number N of fan-outs defined by the design rule or less. If FO is N or less, no buffer needs to be inserted, and therefore, the control routine returns to step 20 so as to select a next signal. In contrast, if FO exceeds N, the control routine proceeds to step 23 in order to insert the buffer.

In the processing in steps 23 and 24, the buffer is inserted into the selected signal so as to configure an N-tree structure. Specifically, the processing is performed as follows:

In step 23, devices, which receive the selected signal as an input, are divided into a plurality of aggregations. That is to say, the number FO of fan-outs of the selected signal is divided by the maximum number N of fan-outs, to be divided into the same number of aggregations as that of the division result.

Thereafter, in step 24, the buffer is inserted in such a manner as to connect the device inside of each of the aggregations with respect to the selected signal. In addition, the control routine returns to step 22, verification is performed again. Until the condition is satisfied, steps 23 and 24 are repeated. As soon as the condition is satisfied, the control routine returns to step 20 so as to select a next signal. If no unprocessed signal remains in accordance with the judgment in step 20, the control routine comes to an end.

Referring to FIG. 1 again, the performance calculating means 8 calculates the performance of the produced net list of the gate level. Here, the performance signifies an area, a delay or the like. The area is determined by the sum of areas of the devices constituting the net list. The delay is determined by the sum of an inside delay and a route delay of the device on a path between registers. The inside delay of the device is obtained from the library 2, and further, the route delay of the device is obtained by multiplying a capacity of the route by a resistance thereof. A model value based on the number of fan-outs can be used as the capacity and resistance of the route. The performance calculating means 8 sets the maximum delay value of a path, which reaches an input pin of each of the devices, as an attribute with respect to the input pin.

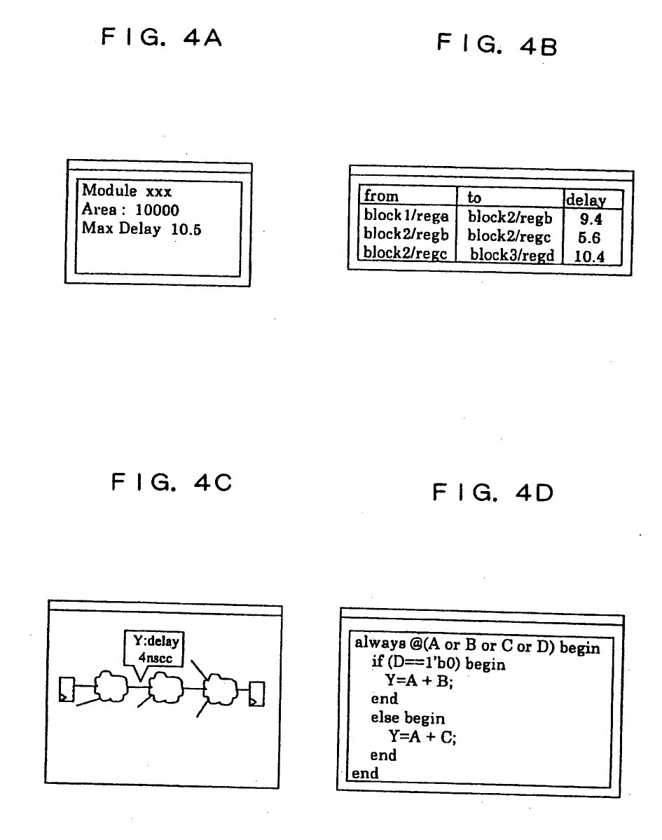

The calculation result by the performance calculating means 8 can be confirmed by the display means 9. FIGS. 4A to 4D illustrate examples of a display by the display means 9.

FIG. 4A illustrates an example of a display of the area and maximum delay of the integrated circuit; and FIG. 4B illustrates an example of a display of a list of the delay of the path between the registers.

FIG. 4C is a circuit diagram illustrating the path displayed by selecting an arbitrary path from the list illustrated in FIG. 4B. The selection of an arbitrary signal in the circuit diagram enables the maximum delay to the signal to be displayed in the circuit diagram. FIG. 4D illustrates the RTL logic description having the correspondence to a signal displayed by selecting a signal having an invariable attribute in the circuit diagram illustrated in FIG. 4C.

On the contrary, the circuit diagram of the path having the maximum delay to a signal can be displayed by selecting an arbitrary signal name from the RTL logic description displayed as illustrated in FIG. 4D.

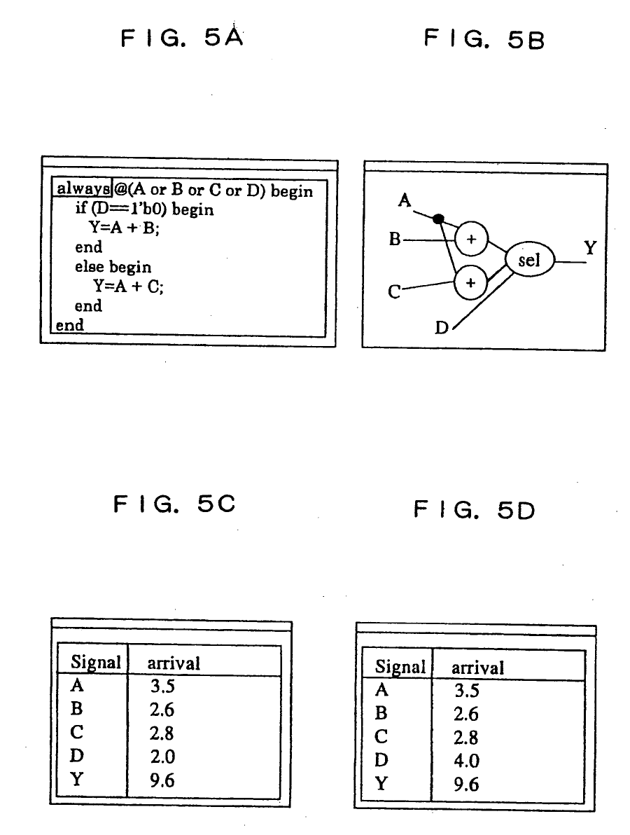

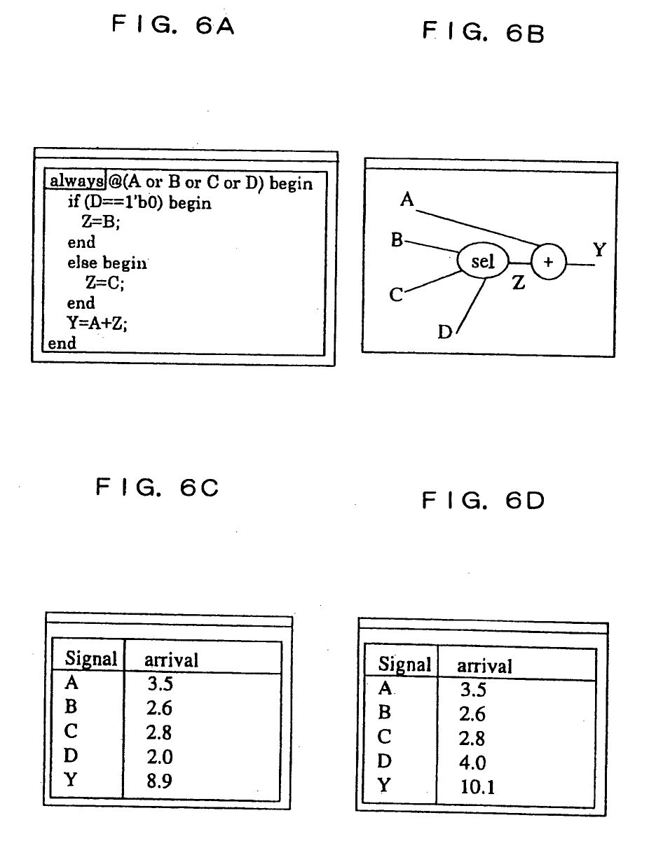

Additionally, the display means 9 displays the reach delay of each of the signals, which reach the corresponding partial circuit, by selecting the always block or the assign sentence on the displayed logic description. The display is exemplified in FIGS. 5A to 5D and 6A to 6D.

FIG. 5A illustrates an example of the logic description, wherein it is assumed that the always sentence is selected. FIG. 5B is a circuit diagram displayed at that time. FIG. 5C illustrates a display of the reach delay of the signal which reaches the partial circuit. In FIG. 5D, the reach delay of a signal D, which is 2.0 in FIG. 5C, is set to 4.0. In comparison between FIG. 5C and FIG. 5D, the delay of the signal Y becomes the same, that is, 9.6 irrespective of the difference of the delay of the signal, that is, 2.0 and 4.0.

FIG. 6A illustrates the case where the RTL description illustrated in FIG. 5A is changed. FIG. 6B illustrates an example of a display of the logic description after the change; FIG. 6B is a circuit diagram; and FIGS. 6C and 6D illustrate a reach delay display.

In the case illustrated in FIGS. 6A to 6D, the reach delay to the signal Y in FIG. 6C is faster (8.9<10.1), and further, is faster than in FIG. 5C (8.9<9.6).

Consequently, an RTL designer notes the reach delay of the signal D, and thus, can evaluate the RTL description to make it as illustrated in FIG. 5A or FIG. 6A.

As described above, provided are the invariable attribute setting means 5, the partial circuit synthesizing means 6 and the invariable part optimizing means 7 in the present embodiment. Thus, the net list can be created in consideration of the timing restriction and the design rule and the kind of device model included in the library 2 such as a composite logic while keeping the correspondence to the RTL logic description. As a result, the performance of the integrated circuit can be estimated with high accuracy at the design stage of the RTL. Furthermore, a faulty portion from the viewpoint of the performance can be specified on the RTL logic description, thereby improving the quality of the RTL logic description.

Moreover, the display means 9 displays the reach delay time of each of the input signals to the partial circuit, so as to achieve the RTL design in consideration of the delay time, thereby improving the quality of the logic description by the RTL.

(Second Embodiment)

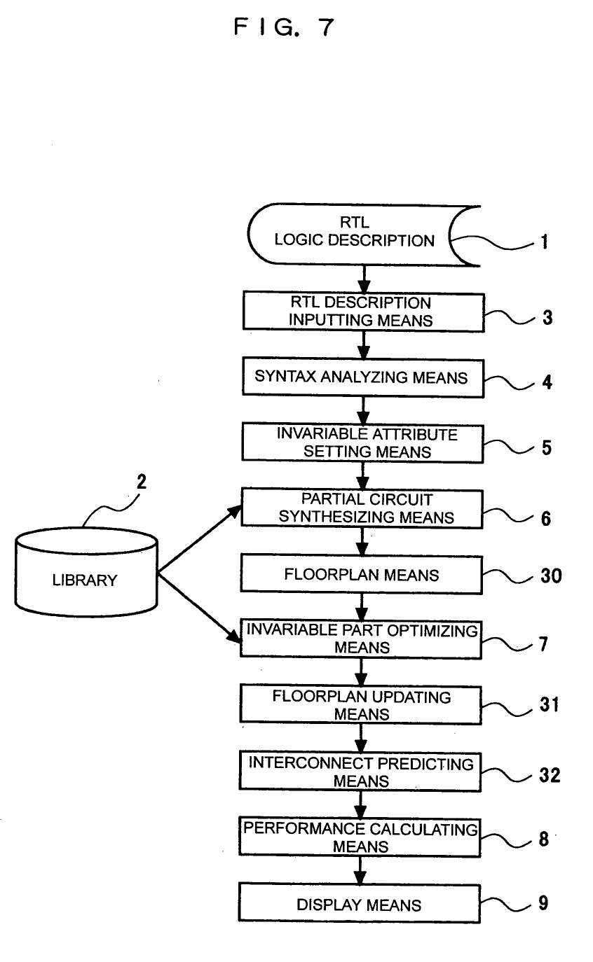

FIG. 7 is a diagram illustrating the configuration of a system for estimating the performance of an integrated circuit in a register transfer level in a second embodiment according to the present invention. A difference from the system for estimating the performance of the integrated circuit in the register transfer level illustrated in FIG. 1 resides in that floorplan means 30 is interposed between partial circuit synthesizing means 6 and invariable part optimizing means 7, and further, that floorplan updating means 31 and interconnect predicting means 32 are interposed between the invariable part optimizing means 7 and performance calculating means 8. Hereinafter, explanation will be made on operation after the floorplan means 30.

First, the floorplan means 30 arranges a device model inside of a net list of a gate level within an arrangement region.

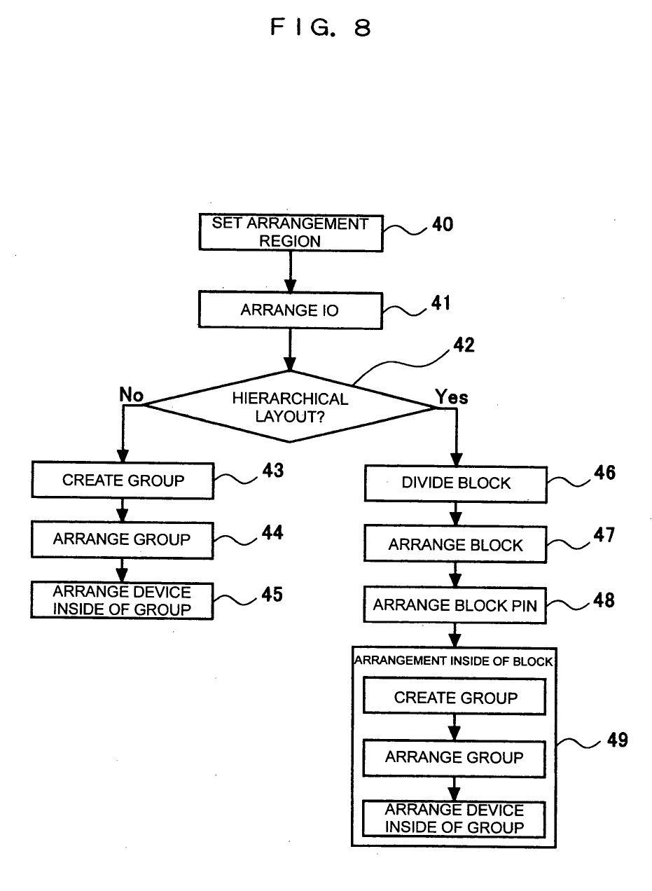

FIG. 8 is a flowchart illustrating operation of the floorplan means 30.

In step 40, an arrangement region is set in accordance with the designated device occupation rate and aspect ratio. The device occupation rate is expressed by a positive real number of 1.0 or less, which represents the rate of a device area occupied in the region. The device occupation rate depends on the number of interconnection layers or the net list at the time of the design of a layout. Before the design of a layout, the device occupation rate is frequently about 0.8 based on an experimental value. The area of the arrangement region is obtained by dividing the total area of the device inside of the net list by the device occupation rate.

Next in step 41, input/output pins or I/O cells are arranged on the periphery of the arrangement region. The arrangement order of the input/output pins or I/O cells is random or designated from the outside.

Subsequently in step 42, it is determined whether or not the layout of an integrated circuit as a target is hierarchically designed. In the case where the hierarchical layout is not designed, the processing in steps 43 to 45 are performed; in contrast, in the case where the hierarchical layout is designed, the processing in steps 46 to 49 is performed. In the case where the scale of the integrated circuit exceeds the scale of a circuit which can be processed by a layout tool to be used, the hierarchical layout is generally adopted. If the scale of a circuit is expressed by the number of gates, a value obtained by dividing the area of the entire devices included in the net list by the area of a device of a 2-input NAND can be regarded as the number of gates in the present embodiment.

First of all, a description will be given below of steps 43 to 45.

In step 43, the partial circuit synthesizing means 6 sets partial circuits whose logic is to be optimized to groups, respectively. In next step 44, the groups are arranged within the arrangement region. At this time, each of the groups has an area obtained by dividing the total area of the device included in the group by the device occupation rate, and is fixed in a square. The arrangement of the group is performed for the purpose of the minimization of an interconnection length connecting the groups and the minimization of the overlapping area of the groups. The interconnection length can be determined by a Manhattan length between the centers of the groups to be connected.

In next step 45, the device model inside of each of the groups is arranged within a region occupied by the group. This arrangement also is performed for the purpose of the minimization of an interconnection length connecting the devices and the minimization of the overlapping area of the devices in the same manner.

Subsequently, a description will be given below of steps 46 to 49.

In step 46, the net list of the gate level is divided into blocks as a unit of the layout design. Each of the blocks is divided in such a manner as to become smaller than the scale of a circuit which can be processed by the layout tool, and it has an area obtained by dividing the total area of the device included in the block by the device occupation rate.

In next step 47, each of the blocks is arranged within the arrangement region. This arrangement is manually designated, or is automatically performed in the same manner as in step 44.

In next step 48, a pin of each of the blocks is arranged on the periphery of the block. This arrangement of the pin is performed for the purpose of the minimization of an interconnection length. In next step 49, the arrangement inside of the block is determined. The processing in step 49 is identical to the processing in steps 43 to 45.

Subsequently, the invariable part optimizing means 7 inserts a buffer with respect to a signal having an invariable attribute in order to satisfy a design rule such as a limitation of the number of fan-outs, as in the first embodiment. Incidentally, since the devices are arranged in the present embodiment, the device receiving the signal is classified in reference to the arrangement position in the processing in step 23 illustrated in FIG. 3. A device classifying method will be shown below. Here, FO represents the number of fan-outs of the signal, and N represents the maximum number of fan-outs of a design rule.

(Device Classifying Method)

(A1) M=FO/N

(A2) Aggregation A={devices outputting the signal}, Aggregation B={devices receiving the signal}

(A3) The movement of a device having greatest distances from all of devices in the aggregation A from the aggregation B to the aggregation A is repeated until the number of devices in the aggregation A becomes (M+1).

(A4) The device outputting the signal is deleted from the aggregation A, and then, the residual devices are made to correspond to aggregations S1, S2, . . . and SM, respectively.

(A5) A distance between each of the devices in the aggregation B and each of the devices in the aggregation A is obtained, and then, the combination of the devices in the aggregations A and B having the smallest distance is obtained, wherein the device in the aggregation B is moved to an aggregation Si (where i is a suffix) which is made to correspond to the device in the aggregation A. When the number of devices in the aggregation Si becomes (N−1), a target device is moved from the aggregation A to the aggregation Si. Here, i is an integer of 1 or more and M or less. This processing is repeated until the aggregation B becomes empty.

Subsequently, the floorplan updating means 31 changes the arrangement region to the area added with the total area of the inserted buffer. In the case of the hierarchical layout, the floorplan updating means 31 changes the arrangement region to the area added with the area of the buffer, into which the block is inserted. Thereafter, the buffers are arranged in such a manner that the interconnection length of the buffer becomes minimum, and further, the arrangement position is finely changed in such a manner that the overlapping between the devices and the overlapping between the blocks become minimum.

Next, the interconnect predicting means 32 interconnects the devices by a Steiner tree.

Thereafter, the performance calculating means 8 calculates an area and a delay, as in the first embodiment. Incidentally, since the device model is arranged in the present embodiment, the capacity and resistance of the interconnection are calculated based on the length of the interconnection determined by the interconnect predicting means 32.

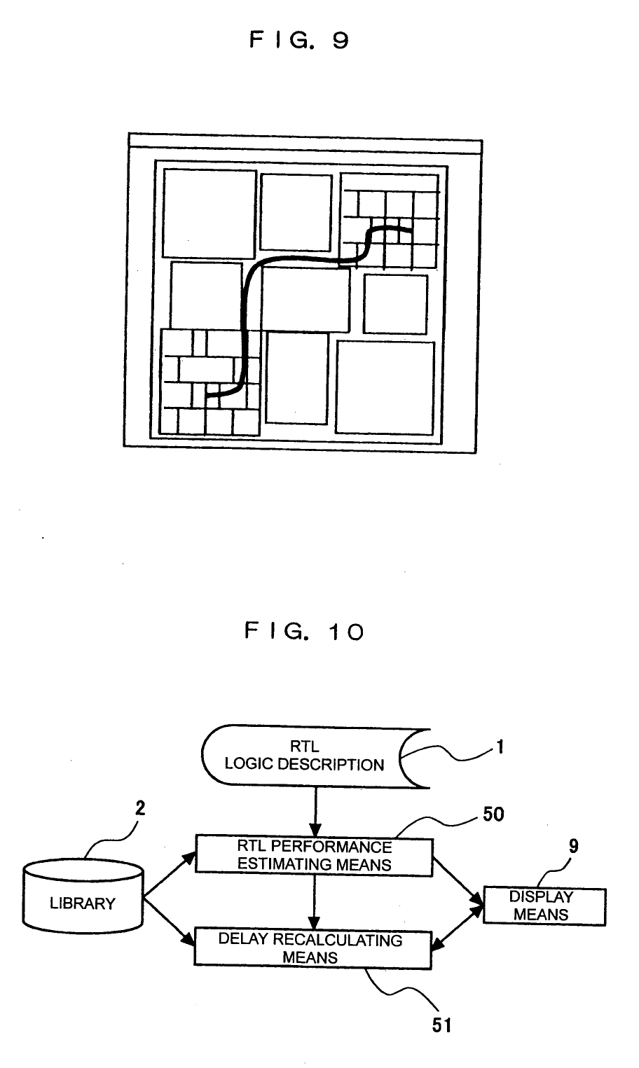

The display means 9 displays a performance calculation result, a circuit diagram and an RTL logic description, as in the first embodiment. Incidentally, there are equipped the functions of displaying a floorplan result with a path selected on a floorplan highlighted in the present embodiment. FIG. 9 illustrates an example of a display of a floorplan.

In the present embodiment, there are provided the floorplan means 30 for arranging the device model and the interconnect predicting means 32 for predicting the interconnection between the devices, thereby estimating the interconnect delay between the devices occupying a great rate with high accuracy in a deep submicron process.

(Third Embodiment)

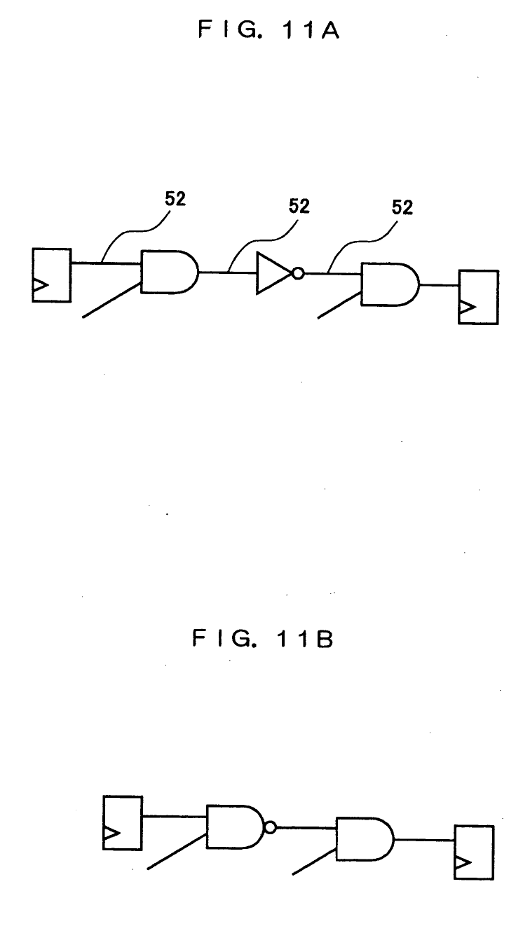

FIG. 10 is a diagram illustrating the configuration of a system for estimating the performance of an integrated circuit in a register transfer level in a third embodiment according to the present invention. In FIG. 10, RTL performance estimating means 50 includes the means from the RTL description inputting means 3 to the performance calculating means 8 in the first or second embodiment. The present embodiment is different from the first and second embodiments in that there is provided delay recalculating means 51. Hereinafter, explanation will be made on operation in the present embodiment.

The delay recalculating means 51 creates a net list whose logic including a signal having an invariable attribute on a selected path is optimized upon a request from the outside. This is performed independently of creation of a net list of a gate level in the entire integrated circuit produced by the RTL performance estimating means 50. And then, a delay of a path in the created net list is recalculated. The calculation result is displayed by the display means 9 after a path delay on a screen illustrated in FIG. 4B is updated.

FIGS. 11A and 11B illustrate examples of the delay recalculating means 51. FIG. 11A illustrates one path in the net list of the gate level produced by the RTL performance estimating means 50; and FIG. 11B illustrates the net list produced by the delay recalculating means 51 with respect to the path. Reference numeral 52 designates a signal having an invariable attribute.

The delay recalculating means 51 in the present embodiment achieves the evaluation of the result of optimization of the logic including a signal having a set invariable attribute. Consequently, the performance can be estimated with higher accuracy while keeping the correspondence to the RTL logic description.

As described above, according to the present invention, the net list can be created in consideration of the timing restriction and the design rule and the kind of device model included in the library such as a composite logic while keeping the correspondence to the RTL logic description. As a result, the performance of the integrated circuit can be estimated with high accuracy at the design stage of the RTL. Furthermore, a faulty portion from the viewpoint of the performance can be specified on the RTL logic description, thereby improving the quality of the RTL logic description.

Furthermore, the floorplan for arranging the device model is performed, thereby estimating the interconnect delay between the devices occupying the great rate with high accuracy in a deep submicron process.

Moreover, the result of logic optimization including the signal having the set invariable attribute, can be evaluated. As a result, the performance can be estimated with higher accuracy while keeping the correspondence to the RTL logic description.

Additionally, the reach delay time of each of the input signals to the partial circuits is displayed, thereby achieving the RTL design in consideration of the reach delay time, so as to improve the quality of the RTL logic description.

Incidentally, although the above-described embodiments are carried out by software by the use of a microcomputer, they may be carried out by hardware in place of the software.

From the above description, it will be apparent what the present invention provides.

What is claimed is:

1. A system for estimating the performance of an integrated circuit in a register transfer level, in which the performance of an integrated circuit is estimated based on a logic description of a register transfer level of the integrated circuit, the system for estimating the performance of an integrated circuit in a register transfer level comprising:
a library storing therein a device model for configuring the integrated circuit;
RTL description inputting means for inputting the logic description and creating the correspondence of a substitution portion with respect to each of signals in the description;
syntax analyzing means for creating a syntax analyzing tree based on the logic description;
invariable attribute setting means for setting an invariable attribute with respect to a signal whose correspondence has been created by the RTL description inputting means in the syntax analyzing tree;
partial circuit synthesizing means for logically optimizing a partial circuit except for a signal having the invariable attribute from the syntax analyzing tree so as to allocate the device model in the library;
invariable part optimizing means for inserting a buffer in order to satisfy a design rule with respect to the signal having the invariable attribute;
performance calculating means for calculating the performance of the integrated circuit; and
display means for displaying the result of the performance calculation and the logic description.

2. A system for estimating the performance of an integrated circuit in a register transfer level, in which the performance of an integrated circuit is estimated based on a net list of a gate level including a signal having correspondence to a logic description of a register transfer level, the system for estimating the performance of an integrated circuit in a register transfer level comprising:
floorplan means for arranging a device model inside of the net list of the gate level within a specified region;
invariable part optimizing means for inserting a buffer based on arrangement information of the floorplan means in order to satisfy a design rule with respect to the signal having the correspondence to the logic description;
interconnection predicting means for predicting the interconnection between devices based on the arrangement information;
performance calculating means for calculating the performance of the net list of the gate level by the use of an interconnection prediction value by the interconnection predicting means; and
display means for displaying the result of the performance calculation, the logic description and the result of a floorplan.

3. A system for estimating the performance of an integrated circuit in a register transfer level as claimed in claim 1, further comprising delay recalculating means for creating the net list whose logic is optimized including the signal having the invariable attribute with respect to a selected path in accordance with a request from the outside, so as to calculate a delay of the path.

4. A system for estimating the performance of an integrated circuit in a register transfer level as claimed in claim 2, further comprising delay recalculating means for creating the net list whose logic is optimized including the signal having the invariable attribute with respect to a selected path in accordance with a request from the outside, so as to calculate a delay of the path.

5. A system for estimating the performance of an integrated circuit in a register transfer level, in which the performance of an integrated circuit is estimated based on a net list of a gate level including a signal having correspondence to a logic description of a register transfer level, the system for estimating the performance of an integrated circuit in a register transfer level comprising:
display means for displaying a reach delay time of each of signals, which reaches a partial circuit on a net list of a gate level corresponding to a specified portion on the logic description.
